(19) United States
(12) Patent Application Publication
(10) Pub. No.: US 2025/0092529 A1
(43) Pub. Date: Mar. 20, 2025

(54) METHOD AND APPARATUS FOR STRIPPING AN OXIDE LAYER FROM A METAL PRODUCT

(71) Applicant: APERAM, Kroll (LU)

(72) Inventors: Ismaël Romaric Alexis GUILLOTTE, VERQUIN (FR); Baptiste Pierre Jean LATOUCHE, LILLE (FR); Marcos Vinicius Oliveira LOPES, LABOURSE (FR)

(21) Appl. No.: 18/292,203

(22) PCT Filed: Jul. 28, 2021
(86) PCT No.: PCT/IB2021/056864

§ 371 Date: Jan. 25, 2024

(51) Int. Cl. C23F 4/02; B23K 26/03; B23K 26/0622; B23K 26/362; B23K 26/70

(52) U.S. Cl. CPC C23F 4/02; B23K 26/032; B23K 26/0622; B23K 26/362; B23K 26/705

(57) ABSTRACT

The method includes determining an oxide layer removal energy density threshold from a section of the product, including transmitting, to a segment of the section, analyzing pulses of wavelength and of pulse duration equal to those of the stripping lasers to form a stripped region, capturing an image of the segment, determining, from this image, a dimension representative of the stripped region and evaluating, from the dimension, the removal energy density threshold; transmitting stripping pulses to the section, the energy density of the stripping pulses being higher than the removal energy density threshold, the stripping laser being controlled in such a way that every point of the section is exposed to an energy density higher than the removal energy density threshold.

This application is the U.S. national phase of International Application No. PCT/IB2021/056864 filed Jul. 28, 2021 which designated the U.S, the entire contents of which are hereby incorporated by reference.

### FIELD

The present invention relates to a method and an apparatus for stripping an oxide layer covering the surface of a metal product, in particular steel, after the latter has been exposed to an atmosphere, which is oxidizing for some of its components, for example during its time in a heat treatment furnace.

In the remainder of this text, the preferred application of the invention will be in the field of stainless steel strips and sheets of all categories (austenitic, ferritic, austenitic-ferritic, etc.), whether hot-rolled or cold-formed. It should be understood, however, that this is by no means limiting, and that the invention may be applied to other metals for which technical problems similar to those encountered on stainless steel strips and sheets, in particular to the various classes of carbon steels and special alloys, especially ferrous alloys. It can also be applied to products other than strips and sheets, for example to wires and welded and seamless tubes, with adaptations to the apparatus described that would be obvious to the person skilled in the art.

### BACKGROUND

It is usual for stainless steel sheets and strips to undergo treatments that lead to an undesirable oxide layer forming at high temperatures on their surfaces, in contact with an oxidizing atmosphere such as air. The composition of these oxides varies substantially according to the composition of the base metal and the conditions under which they are formed. Most commonly, oxides of the elements Fe, Cr, Mn and Si predominate.

The treatments that lead to this formation are typically, but not limiting, the reheating that a semi-finished product (ingot, slab, bloom, billet) undergoes prior to hot rolling and its time in the open air that it undergoes after hot rolling, and the various annealing processes at several hundred degrees that the strip or sheet undergoes before and/or during and/or after its cold rolling cycle (the latter being carried out in one or more stages, some of which may be separated by an intermediate annealing process), if this annealing takes place in an atmosphere that is not perfectly inert or reducing. These undesirable oxides must, of course, be removed before the sheet or strip becomes a usable product or semi-finished product ready to undergo the final shaping operations that will make it a usable product. It is also often important to remove these oxides before the first cold rolling stage, to prevent them from embedding themselves in the surface of the semi-finished product during rolling and leading to poor surface finish.

It must be understood that the undesirable oxide layer referred to here is not the thin Cr oxide-based layer (known as the “passive layer”) that forms spontaneously in air and at room temperature on the surface of stainless steels, protecting them from oxidation. The oxide layer that poses a problem, and that we wish to remove, is the one that forms during the time the strip spends in an oxidizing atmosphere at high temperature. Once this layer has been removed, the surface of the stainless steel is exposed and the protective passive layer of Cr oxides can form again, rapidly and spontaneously, making the steel stainless again under normal conditions of use.

The use of mechanical descaling by shot blasting (projection of hard balls onto the surface to be treated) and/or by oxide breaking (passage of the strip between pairs of rollers which work it in flexion, compression and traction) allowing to crack and remove easily, for example by brushing, a large portion of the oxides, but may not be sufficient to remove all. Shot blasting also has the disadvantage of increasing surface roughness, which subsequent operations on the sheet or strip may not allow it to be corrected, when this is not wanted.

Most commonly, the unwanted oxide layer is removed by means of a chemical or electrolytic stripping method, or a succession of such stripping operations.

Chemical stripping is carried out in one or more baths of hydrofluoric, hydrochloric, sulfuric or nitric acid. Electrolytic stripping is typically carried out in a sodium sulfate bath or an acid bath (nitric or sulfuric).

These stripping operations result in the obtention of a strip or sheet presenting a surface finish that is usually classified into various standard categories:
Finish 1D, for products that have undergone hot rolling, annealing and stripping, generally chemical stripping; mechanical stripping (oxide breaking, shot blasting) is also generally used upstream of chemical stripping;
Finish 2B, for products that have undergone annealing, stripping, generally electrolytic and chemical and skin-passing (a work-hardening rolling mill that improves strip flatness and reduces roughness, with a low rate of reduction in product thickness, usually of the order of a few %);
Finish 2D for cold-rolled products that have been annealed and stripped, but not skin-passed;
Finish 2E for cold-rolled products that have been annealed, shot-blasted, stripped and not skin-passed.

Chemical stripping is the most radical method for removing unwanted oxides. But it has many drawbacks.

It consumes large quantities of acids, with, at most, very limited possibilities of recovering a portion for later reuse.

The infrastructure required for the method, that is, successive stripping baths and their ancillaries, is costly and cumbersome. It is not uncommon to find chemical stripping plants for conveyor belts up to 200 m long.

These apparatuses use hazardous products, in particular hydrofluoric acid. Their liquid and solid pollutant discharges (sludge containing oxides mixed with stripping liquids) have to be stored and reprocessed according to strict regulations, the severity of which can only increase in the future, which is costly. Acid baths, when heated, also transmit acid vapors that must be neutralized. Nitric acid is also a source of NOx emissions, which must be captured and treated.

Electrolytic stripping methods are also used, carried out while the strip or sheet is immersed in a bath generally based on sodium sulfate, nitric or sulfuric acid, which must also be reprocessed after use. Electrolytic stripping requires a fairly costly apparatus using a relatively large amount of electrical energy. It can be supplemented by chemical acid stripping, which is lighter than chemical stripping alone, but presents the same drawbacks as those mentioned above. Electrolytic stripping also produces sludge, which must be stored and reprocessed. Spent baths must be reprocessed. Sludge and bath reprocessing is less costly, dangerous and complex than in the case of chemical stripping with acid baths, but still constitute a very significant constraint on the use of the method.

Finally, the presence of hexavalent chromium in solution in the stripping liquids represents a major health risk for personnel and the environment: its levels in liquids and the exposure of personnel are measured and monitored.

We have therefore examined the possibilities of replacing, at least in certain cases, chemical or electrolytic stripping of metal products by methods making use of a laser. The classic book “Laser Cleaning” (Boris Luk'yanchuk, December 2002, ISBN: 978-981-02-4941-0) discusses such possibilities, particularly for cleaning works of art and buildings (in particular, chapter 2, “an overview of experimental research into the laser cleaning of contaminants from surfaces”), thus for relatively small, fixed surfaces. The laser beam is projected onto the surface to be cleaned, causing the oxide layer to detach.

In this manner, the use of acids and/or sulfates is avoided, and there is no longer need to reprocess polluting and hazardous sludge and liquids. Only the detached oxides need to be collected, for example by suction, and it is possible to reprocess them, preferably by the dry method, to recover and recycle the metals they contain. The safety of personnel and the workshop environment is better assured. The whole laser surface cleaning operation also presents a better overall energy balance than by wet cleaning (chemical and/or electrolytic), as far as the electricity cost of the laser operation is not very high, in particular relative to that necessary for electrolytic stripping. The apparatus can be much more compact than an apparatus for stripping including several successive baths, with clear advantages in terms of the cost of civil engineering operations when building the apparatus. If pulsed lasers are used, it is possible to deliver high energy levels in a very short time, at high frequency and with great autonomy, and the service life of these lasers can reach several years without any particular maintenance.

However, the use of existing technologies, coupled with CO₂ or excimer lasers, does not allow optimum results to be obtained on the strips or sheets, on industrial scale lines, due to heavy maintenance, a continuous operating mode of the lasers or with pulses that are too long, and the high operating cost due to the number of lasers used, given the high speed of current lines. Furthermore, the solutions offered assume a uniform surface condition according to the width and length of the strip (see EP 0 927 595-A1) and, more often than not, a fixed line speed. On the same strip, if the speed of the line changes for a specific reason, the inertia of the machines, especially that of the furnace, leads to a modification of the oxide layer (in thickness and/or type). Even if the nature and thickness of the oxide layer to be removed were previously considered to be known, these are then modified, and an adaptation of the pulse frequency or energy only works if the oxide layer does not change (which is not generally the case). Finally, line speeds are now reaching around 100-150 m/min.

The document EP3631049 A1 describes a method for stripping an oxide layer, in which the composition of the oxide layer as well as the thickness are determined by laser-induced plasma spectroscopy.

This technique is not satisfactory, as it requires damage to the metal beneath the oxide layer. In addition, determining the thickness and composition of the oxide layer does not allow, in a reliable manner, to determine which stripping parameters should be used to strip the oxide layer.

The document WO2018/096382 further describes a method and an apparatus for laser stripping of metal products.

According to this method, the emissivity of the oxidized surface of the metal product to be stripped is determined by transmitting a beam onto this surface by means of a first laser, intercepting the beam reflected by the oxidized surface, and analyzing these reflected beams. The operating parameters of the stripping lasers are then adapted as a function of the emissivity thus determined.

This method allows to adapt the energy transmitted by the stripping lasers to effectively strip the oxide layer present on the surface.

However, this method is not entirely satisfactory, as the emissivity does not always allow to determine the right parameters for effective stripping of the oxide layer.

One aim of the invention is therefore to propose a method and an apparatus for stripping running metal products, allowing effective stripping to be obtained on an industrial scale.

### SUMMARY

To this end, the invention has as its object a method for stripping a running metal product presenting an oxide layer on its surface, said method using laser stripping by means of at least one stripping laser, the method comprising the following steps, implemented successively on each section of a plurality of consecutive sections of the running product:
determination of an oxide layer removal energy density threshold on the section under consideration of said running metal product, corresponding to a minimum energy density necessary for removal of the oxide layer on the section under consideration, comprising:
transmission of analysis laser pulses by an transmission system comprising a laser source, the analysis laser pulses being of equal wavelength and pulse duration to those of the stripping laser(s), over a segment of said section under consideration, to form, within said segment, a stripped region devoid of the oxide layer,
capture of an image of the segment of the surface impacted by said analysis laser pulses,
determining, from said image, a dimension representative of the stripped region,
evaluation, from said representative dimension and information relating to the energy profile of the analysis laser pulses, of the oxide layer removal energy density threshold,
transmission by the stripping laser of stripping laser pulses on the section under consideration to strip it, the energy density of the stripping pulses being higher than the determined oxide layer removal energy density threshold,
the stripping laser being controlled by a control unit receiving the determined oxide layer removal energy density threshold in such a way that each point of the section under consideration is exposed for at least one instant to an energy density higher than the oxide layer removal energy density threshold.

According to other advantageous aspects of the invention, the method comprises one or more of the following features, taken alone or in any technically possible combination:
transmitting the analysis laser pulses shape, within said segment, a damaged region, on which the metal underlying the oxide layer has been damaged, and the method further comprises determining, from said image, a dimension representative of the damaged region and evaluating, from the dimension representative of the damaged region and the information relating to the energy profile of the analysis laser pulses, of a metal damage energy density threshold, corresponding to the energy density above which degradation of the surface of the metal product, beneath the oxide layer, is observed;
the method further comprises a transmission of the damage energy density threshold to the transmission system, and, on the next section of the running metal product, the transmission system transmits an analysis laser pulse of energy adapted in such a way that at any point of the segment impacted by the analysis laser pulses, the energy density is lower than the damage energy density threshold;
the information relating to the energy profile comprises the shape of the energy profile and the energy or power of the analysis laser pulses;
the step of determining the oxide layer removal energy density threshold comprises determining the shape of the energy profile of the analysis laser pulses and/or determining the energy or power of the analysis laser pulses;
the step of determining the oxide layer removal energy density threshold comprises determining the shape of the energy profile of the analysis laser pulses, comprising diverting a portion of each analysis laser pulse toward a beam analyzer and evaluating the shape of the energy profile by the beam analyzer;
the step of determining the oxide layer removal energy density threshold comprises determining the energy and/or power of the analysis laser pulses, comprising diverting a portion of each analysis laser pulse toward a power meter, and evaluating the energy and/or power of the analysis laser pulses by the power meter;
the step of determining the oxide layer removal energy density threshold comprises determining the shape of the energy profile and/or the energy or power of auxiliary laser pulses transmitted by the transmission system, the auxiliary laser pulses being distinct from the analysis laser pulses;
determining the shape of the energy profile and/or the energy or power of the auxiliary laser pulses comprises:
transmission of auxiliary laser pulses by the transmission system,
directing the auxiliary laser pulses toward a beam analyzer and/or toward a power meter by means of a mirror galvanometer scanning device,
evaluating the shape of the energy profile of the auxiliary laser pulses by the beam analyzer and/or evaluating the energy and/or power of the auxiliary laser pulses by the power meter;
the metal product is a strip, bar, sheet, plate, tube or wire.

The invention also has as its object an apparatus for laser stripping of a running metal product presenting an oxide layer on its surface by means of at least one stripping laser, characterized in that it includes:
a determination assembly configured to determine, on each of a plurality of successive sections of the running metal product, an energy density threshold for removal of the oxide layer, corresponding to a minimum oxide layer removal energy density necessary for the section under consideration, the determination assembly comprising:
an transmission system comprising a laser source, the transmission system being configured to transmit, over a segment of said section under consideration, the analysis laser pulses of wavelength and pulse duration equal to those of the stripping laser(s), to form, within said segment, a stripped region devoid of the oxide layer,
an image acquisition system configured to acquire an image of the segment impacted by the analysis laser pulses, during movement of the product,
a treatment system configured to determine, from each image acquired by the image acquisition system, a dimension, representative of the stripped region and to evaluate, from said representative dimension and information relating to the energy profile of the analysis laser pulses, the oxide layer removal energy density threshold,
a laser stripping assembly comprising at least one stripping laser configured to transmit stripping laser pulses on each of the plurality of successive sections of the running metal product to strip it, and a control unit configured to receive the oxide layer removal energy density threshold for that section under consideration and to control the transmission, by the stripping laser(s), of laser pulses of energy higher than the oxide layer removal energy density threshold, in such a way that each point of the section under consideration is exposed for at least one instant to an energy density higher than the oxide removal energy density threshold.

According to other advantageous aspects of the invention, the apparatus comprises one or more of the following features, taken alone or in any technically possible combination:
the analysis laser pulses are able to shape, within said segment, a damaged region, on which the metal underlying the oxide layer has been damaged by the analysis laser pulses, and the treatment system is configured to determine, from said image, a dimension representative of the damaged region and to evaluate, from the dimension representative of the damaged region and the information relating to the energy profile of the analysis laser pulses, a metal damage energy density threshold, corresponding to the energy density above which degradation of the surface of the metal product, under the oxide layer, is observed;
the treatment system is configured to transmit the damage energy density threshold to the transmission system, and the transmission system is configured to adapt the energy of the analysis laser pulse as a function of the damage energy density threshold in such a way that at any point of the impacted segment of the next section of the running product, the energy density is lower than the damage energy density threshold;
the information relating to the energy profile comprising the shape of the energy profile and the energy or power of the analysis laser pulses;
the apparatus for laser stripping comprises a system for determining the shape of the energy profile of the analysis laser pulses and/or a system for determining the energy or power of the analysis laser pulses;
the system for determining the shape of the energy profile of the analysis laser pulses comprises a beam analyzer and an optical device, in particular a beam splitter, configured to deflect a portion of each analysis laser pulse toward the beam analyzer, the beam analyzer being configured to evaluate the shape of the energy profile from the deflected portion of the analysis laser pulse;
the system for determining the energy or power of the analysis laser pulses comprises a power meter and an optical device, in particular a beam splitter, configured to deflect a portion of each analysis laser pulse toward the power meter, the power meter being configured to evaluate the energy and/or power of the analysis laser pulses from the deflected portion of the analysis laser pulse;
the information relating to the energy profile comprising the shape of the energy profile and the energy or power of the analysis laser pulses, the laser stripping apparatus comprises a system for determining the shape of the energy profile and/or the energy or power of auxiliary laser pulses transmitted by the transmission system, the auxiliary laser pulses being distinct from the analysis laser pulses;
to treat the entire surface of said metal product, which consists of a strip, a bar, a tube, a sheet, a plate or a wire, it comprises, distributed in the vicinity of said metal product, a group of laser sources and a group of stripping lasers.

The invention also relates to a continuous treatment line for a metal product comprising an apparatus for stripping according to the invention.

### BRIEF DESCRIPTION OF THE DRAWINGS

The invention will be better understood on reading the following description, given with reference to the appended figures, among which:

FIG. 1 schematically illustrates, in profile, a continuous line comprising an apparatus for laser stripping according to one embodiment of the invention;

FIGS. 2 to 4 illustrate three examples of laser pulse energy profiles 34, 35, 36;

FIGS. 5 to 7 illustrate three examples of surface aspects resulting from transmitting laser pulses having the energy profiles illustrated in FIGS. 2 to 4 respectively;

FIG. 8 schematically illustrates a portion of an apparatus for stripping according to a second embodiment;

FIG. 9 illustrates a detail of the apparatus for stripping in FIG. 8;

FIG. 10 schematically illustrates a portion of an apparatus for stripping according to a third embodiment.

### DETAILED DESCRIPTION OF EMBODIMENTS

The apparatus for laser stripping which will be described in detail and illustrated by means of examples with reference to the treatment of a cold-rolled stainless steel strip in movement, having just undergone cold rolling and annealing on a continuous line, and the apparatus for laser stripping according to the invention, which ensures at least the essential part of this stripping function, is also integrated into this continuous line, replacing or upstream of the electrolytic and/or chemical stripping systems usually used on this type of continuous line (examples of such continuous lines can be found, notably in documents EP 0 509 177-A2 and EP 0 695 808-A1).

It goes without saying that the apparatus for laser stripping described here can also be integrated into a continuous treatment line including more or less equipment than described here or be the subject of a separate apparatus specially dedicated to this stripping.

Also, not shown, is the equipment usually present on such lines, which have no major metallurgical role and, in any case, are not involved as such in the laser stripping operation carried out according to the invention. In particular mention can be made of the pinch rollers for starting in movement the strip, and strip accumulators that act as “buffers” between some of the equipment, each of which may require a different strip speed.

The continuous line represented includes an unwinding apparatus 1 for a coil 2 of hot-rolled stainless steel strip 3, the thickness of which is typically a few tenths of a mm or a few mm and up to 2 m wide. This strip 3 moves at a speed of typically up to 150 m/min, and, generally after being stripped by any chemical and/or mechanical means, not shown, or even by laser with means according to the invention as will be described, it passes into a cold rolling mill 4, which reduces its thickness to a value that is typically of the order of 0.2 to 15 mm in order to obtain a cold-rolled strip.

The cold-rolled strip 3 then passes into an annealing furnace 5, where it is heated to a temperature of several hundred degrees, this temperature being adapted as a function of the metallurgical objectives of the annealing. If this annealing is carried out (deliberately or accidentally) in the presence of a non-negligible quantity of an oxidizing gas such as oxygen, it leads to the formation of an undesirable oxide layer on the surface of the strip 3, the composition, thickness and adhesion of which, on the strip 3 depends in particular on the composition of the strip 3, the composition of the atmosphere in the furnace 5, the temperature in the furnace 5, and the length of time, of the strip 3, in the furnace 5. In view of these numerous parameters, not all of which are easily controllable and which, in any case, can vary substantially according to the precise treatment carried out (in particular the composition of the strip 3 and the annealing conditions), as well as production hazards, it is not possible to assign precise systematic characteristics to this oxide layer that would allow easy standardization of the stripping conditions for the strip 3. This is also one of the disadvantages of wet stripping methods, particularly chemical, where the composition of the baths cannot be easily adapted to what would actually be required to obtain satisfactory stripping of the strip 3 at the lowest cost.

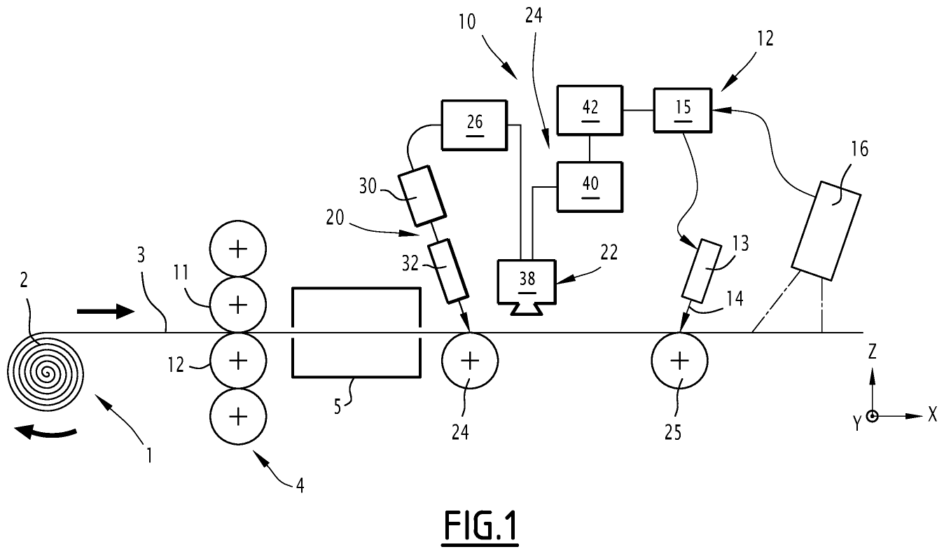

According to the embodiment shown in FIG. 1, the apparatus for laser stripping is arranged in the line after the annealing furnace 5.

The apparatus for laser stripping includes an energy density threshold determination unit 10 and an apparatus for laser stripping 12.

The energy density threshold determination assembly 10 is intended to evaluate the effective energy density necessary to strip the oxide layer on the running strip. Indeed, it is possible, due to voluntary or involuntary variations, in operating parameters upstream of the line, for example, slowing down or acceleration of the strip on the line, or even heterogeneous pollution over the width of the strip 3 that has occurred in the furnace 5, before or after this, to obtain a heterogeneous oxide layer over the length and/or width of the strip 3 to be stripped.

The energy density threshold determining assembly 10 is intended to determine, during movement of the metal product to be stripped, a minimum value or energy density threshold, hereinafter referred to as the oxide removal energy density threshold Sₑₓₚ, corresponding to the minimum energy density to be transmitted by the apparatus for laser stripping 12 onto the product in order to strip the oxide layer present on the product surface. Preferably, the energy density threshold determining assembly 10 is further configured to determine a maximum laser energy density threshold, hereinafter referred to as the damage energy density threshold S_{end}, above which degradation of the product surface, that is, the metal, beneath the oxide layer, is observed.

The determination assembly 10 is configured to determine the oxide removal energy density threshold Sₑₓₚ, and, if applicable, the damage energy density threshold S_{end}, successively on a plurality of sections of the product surface.

A section is, for example, a transverse strip of given length in the direction of movement of the product (also known as the longitudinal direction) and width equal to that of the product. Such a strip is referred to as an “elementary strip”, as opposed to the product when it is in strip 3 form. The sections are then intended to be stripped one after the other by the apparatus for laser stripping 12, as they pass in front of the apparatus for laser stripping 12.

Preferably, as described below, the determination assembly 10 is configured to determine the oxide removal energy density threshold Sₑₓₚ and, if applicable, the oxide removal energy density threshold Sₑₓₚ on a segment of each section, the threshold(s) thus determined then being considered as representative of the entire section under consideration.

For example, a section being a transverse elementary strip of given length in the direction of movement of the product and of width equal to that of the product, the determination assembly 10 is configured to determine the oxide removal energy density threshold Sₑₓₚ and, if applicable, the oxide removal energy density threshold Sₑₓₚ on a segment of this elementary strip, the threshold(s) thus determined then being considered as representative of the entire elementary strip.

The apparatus for laser stripping 12 is intended to transmit laser beams onto the running product in order to strip the oxide layer, as a function of the energy density threshold(s) determined by the determination assembly 10.

In particular, the apparatus for laser stripping 12 is intended to transmit laser beams onto each section of the running product in order to strip the oxide layer, as a function of the energy density threshold(s) determined by the determination assembly 10 for this section.

The energy density threshold determination assembly 10 comprises a laser pulse transmission system 20, an image acquisition system 22, a treatment system 24 and a controller 26.

The laser pulse transmission system 20 is configured to transmit, onto the running product, a beam of laser pulses of a wavelength and pulse duration equal to that of the lasers to be used for stripping (for example, Nd:YAG lasers with a wavelength of 1064 nm). These laser pulses will hereinafter also be referred to as analysis laser pulses.

The laser pulse transmission system 20 comprises at least one laser source 30 able to transmit such analysis laser pulses. The laser source 30 is able to transmit laser pulses of the same wavelength and pulse duration as the lasers to be used for stripping.

The fact that the wavelength and pulse duration of the laser source 30 are the same as those of the stripping lasers allows to ensure that the absorptions of the rays from the laser source 30 by the oxides covering the product will be the same as for the stripping lasers, and that the settings of the stripping lasers can therefore be based directly on the data obtained by the energy density threshold determination unit 10.

Preferably, the laser source 30 is mounted so as to be movable relative to the line, in particular movable in a direction parallel to the product surface and orthogonal to the direction of movement of the product (in other words, movable according to the product width). It is thus possible to vary, across the width of the product, the location of the segment of the product impacted by the laser source during movement. To this end, the laser pulse transmission system 20 comprises, for example, a scanning device able to displace the laser source transversely to the running product. Alternatively, the determination assembly 10 is entirely movable relative to the line, which also allows to vary, across the width of the product, the location of the segment of the product impacted by the laser source during movement.

For example, if each section considered is an elementary strip the width of which is equal to that of the product to be stripped, the scanning device is able to displace the laser source transversely to the running product in such a way that the location of the segment of the product impacted by the laser source varies over time across the width of product (strip) 3.

The laser pulse transmission system 20 also comprises an optical device 32 configured to focus the laser pulses transmitted by the laser source 30 onto the surface of the running product.

The laser source 30 is configured to transmit an analysis laser pulse onto a segment of the section under consideration of the surface of the running product, the energy density of which varies as a function of the position on this segment. Thus, the energy density received at each point of the impacted segment will depend on the position of that point. The region of the product surface impacted by the analysis laser pulse will hereafter be referred to as a “spot”.

For example, at certain points, the energy density received will be too low to strip the oxide layer, while at other points, the energy density will be sufficient to strip the oxide layer, yet insufficient to damage the metal underneath. In certain cases, the energy density received at certain points may be sufficient to both strip the oxide layer and damage the metal beneath the oxide layer.

The energy density received at each point of the impacted segment is characterized by the energy density profile, or more simply energy profile, of the pulse.

The energy profile thus associates, at each position, or at a plurality of positions, in the plane of the product surface with an energy density transmitted at that position.

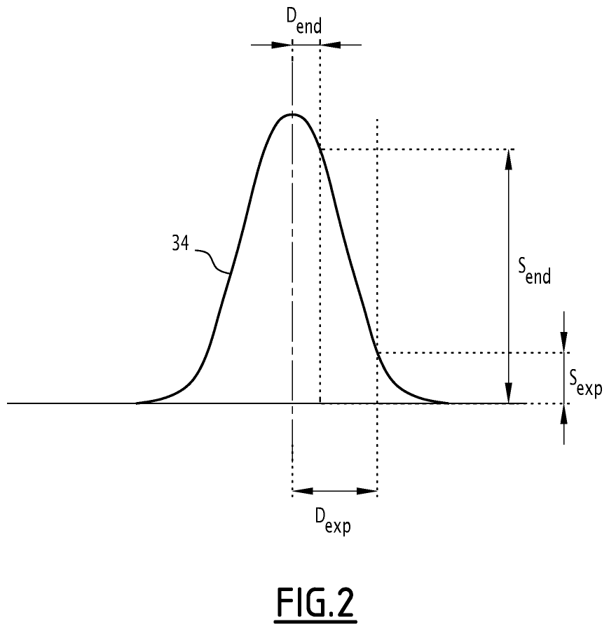

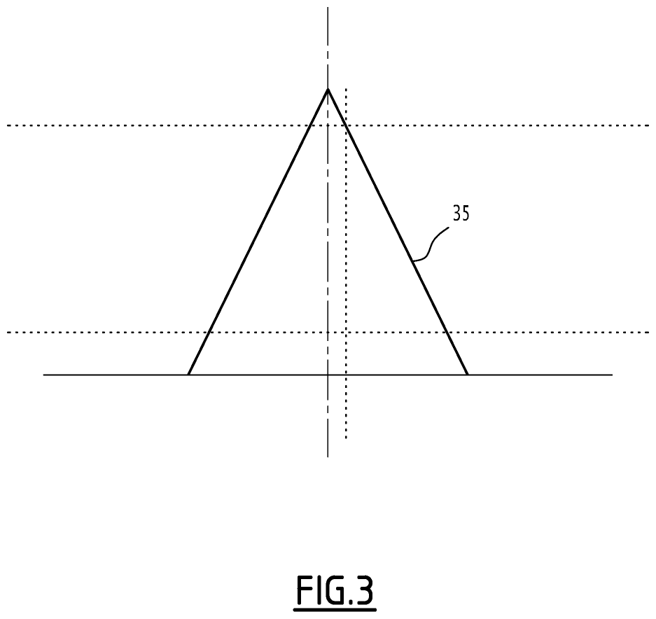

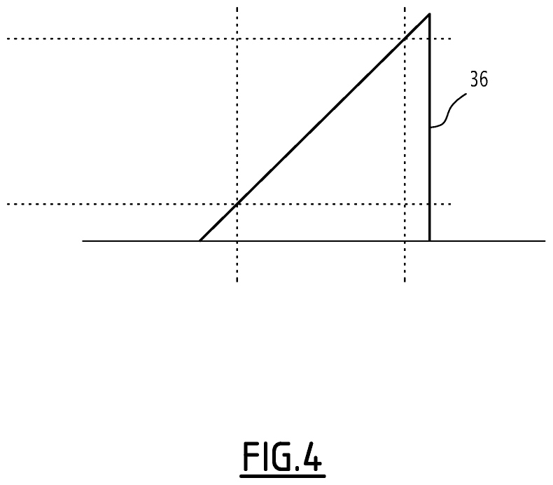

FIGS. 2, 3 and 4 illustrate respectively three examples of energy profiles 34, 35, 36. In the three profiles illustrated, the abscissa axis X represents the position along an axis included in the plane of the product surface, and the ordinal axis Y is the energy density received at that position. Each point on the energy profile is therefore associated with a given position, the energy density received at that position.

For example, the pulse presents an axis of symmetry Z parallel to the direction of pulse propagation (the pulse impact on the product being circular, for example), and the energy profile associates an energy density with each distance relative to the center of the circle formed by the pulse impact (or pulse center).

The energy profiles 34 and 35 are examples of such a profile.

The energy profile 34 is circular in shape, that is, such that all points at the same distance from the pulse center receive the same energy density.

The energy profile 35 is square in shape, such that all points located on the sides of a square with the center of the pulse as its center receive the same energy density.

According to another example, the impact of the pulse on the product is such that the energy density on the impacted segment is constant according to an axis Y, orthogonal to the direction of pulse propagation, and the energy profile associates an energy density to each position along an axis X orthogonal to the axis Y and to the direction of pulse propagation.

The energy profile 36 is an example of such a profile. In this example, the energy density is an increasing linear function of position along the axis X.

Preferably, as illustrated for example, by the profile 34, the energy profile is Gaussian, that is, such that the energy density received in a plane orthogonal to the direction of pulse propagation follows a Gaussian distribution.

The energy profile of a Gaussian pulse can be expressed as follows:

$$E ( x ) = {E}_{p i {c}^{⋆}} exp ( - {x}^{2} / 2 {σ}^{2} )$$

with E_{pic}=Eₚᵤₗₛₑ/(2 πσ²)
where:
E_{pic} is the peak energy density of the Gaussian.
Eₚᵤₗₛₑ is the pulse energy,
x is the distance to the center of the pulse,
E(x) is the energy density received at distance x from the center of the pulse,
σ is the standard deviation of the Gaussian.

Preferably, the energy density profile presents a low slope, in other words, the derivative of the energy density relating to position is less than 1. In particular, if it is a Gaussian profile, it is such that σ>E_{pic}*exp(−½).

Preferably, the laser source 30 is configured to transmit laser pulses with a known energy profile.

Alternatively, as described below, the energy profile of the laser pulses is not known a priori, and the energy density threshold determination assembly 10 in addition, includes a determination system for the energy profile of the pulse transmitted by the laser source.

In all cases, the energy profile is characterized by its shape (as shown in FIGS. 2 to 4) and by the power or the energy of the pulse.

The image acquisition system 22 is configured to acquire, for each product section under consideration, an image of the segment impacted by the laser pulses transmitted by the transmission system 20, during movement of the product.

The image acquisition system 22 comprises, for example, a camera 38, in particular a high-resolution camera. In operation, the camera 38 is positioned in front during movement of the product.

The controller 26 is configured to synchronize the laser pulse transmission system 20 and the image acquisition system 22. In particular, the controller 26 is configured to control the transmission of laser pulses by the transmission system 20 and to control the acquisition of an image of the region impacted by these pulses by the image acquisition system 22.

The treatment system 24 is configured to determine, from each image acquired by the image acquisition system 22, the oxide removal energy density threshold Sₑₓₚ, corresponding to the minimum energy density required to remove the oxide layer from the section under consideration.

Preferably, the treatment system 24 is further configured to determine, from each image acquired by the image acquisition system 22, the metal damage energy density threshold S_{end}, corresponding to the energy density above which a degradation of the product surface, beneath the oxide layer, is observed.

To this end, the treatment system 24 is configured to receive each image acquired from the image acquisition system 22.

The treatment system 24 is furthermore configured to receive information relating to the energy profile of the laser pulse transmitted onto the running product by the laser pulse transmission system 20, in particular by the laser source 30.

The treatment system 24 comprises, for example, an image analyzer 40 and a threshold determination module 42.

The image analyzer 40 is configured to determine, by analysis of each acquired image as transmitted by the image acquisition system 22, at least one dimension of a stripped region of the metal product surface, that is, devoid of oxide.

The image analyzer 40 is able to determine information relating to the stripped region, in particular at least one dimension representative of the shape of this region, in particular the contour of this region.

For example, in the case of a pulse of which the energy density profile is Gaussian, the stripped region has a circular shape, and a dimension representative of this shape is, for example, the diameter, radius, circumference or area of the circular region.

According to another example, the stripped region is rectangular in shape, and the dimension representative of this shape is the length and/or width of the rectangular region.

The image analyzer 40 is able to transmit information relating to the stripped region to the threshold determination module 42.

Preferably, the image analyzer 40 is in addition configured to determine at least one dimension of a damaged region of the surface of the metal product, in other words, a region where the metal underlying the oxide layer has been damaged.

The threshold determination module 42 is able to receive this information.

The threshold determination module 42 is furthermore able to receive information relating to the energy profile of the laser pulses the transmission of which generated the stripped region. This information generally comprises the shape of the energy profile and the power or the energy of the pulse.

In particular, the laser source having transmitted a pulse at an instant tₑ on a segment of the product section under consideration, the image of this segment having been acquired at an instant tₑ+Δt, the information relating to the energy profile of the laser pulses is representative of the laser pulses transmitted at the instant tₑ.

This information relating to the energy profile of the laser pulses is stored, for example, in a memory of the threshold determination module 42.

The threshold determination module 42 is able to determine, from the information relating to the energy profile and the information relating to the stripped region, the oxide removal energy density threshold Sₑₓₚ.

Preferably, the threshold determination module 42 is furthermore configured to determine, from the information relating to the energy profile and the information relating to the stripped region, the metal damage energy density threshold S_{end}.

To this end, the threshold determination module 42 is able to determine, from the energy profile of the laser pulse, which energy density led to the stripping to obtain the stripped region.

For example, the threshold determination module 42 is able to determine, from the energy profile, which energy density is received on the contour of the stripped region, this energy density then corresponding to the minimum energy density for stripping the oxide layer.

In particular, if the pulse transmitted by the transmission system 20 is a Gaussian pulse, the stripped region being circular of diameter D, the oxide removal energy density threshold Sₑₓₚ is expressed in the form

$${S}_{exp} = {E}_{p i {c}^{⋆}} exp ( - {D}^{2} / 8 {σ}^{2} ) .$$

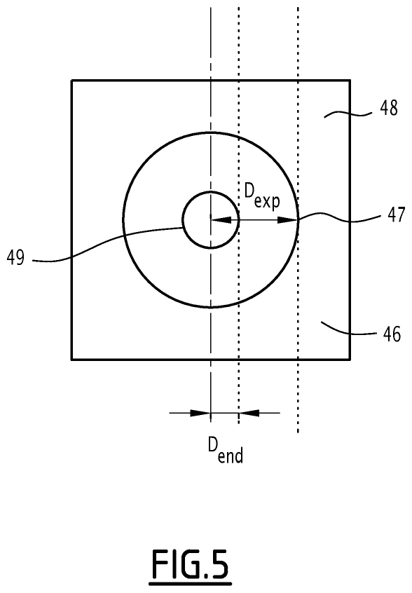

By way of example, FIGS. 5 to 7 show a segment of the product surface impacted by the pulse having a profile as illustrated in FIGS. 2 to 4 respectively.

As shown in FIG. 5, the surface 46 results from transmitting the pulse with energy profile 34. The contour 47 delimits the stripped, region of the product, devoid of oxide. The surface 46 thus comprises an unstripped segment 48 and a circular stripped region delimited by the contour 47. The stripped region comprises a central damaged region, delimited by a circular contour 49.

The stripped region is formed by the points on the surface 46 having received sufficient energy density to strip the oxide layer. The contour 47 of the stripped region is thus formed by the points having received an energy density equal to the oxide removal energy density threshold Sₑₓₚ.

As illustrated in FIG. 5, the determination of a dimension, in the example presented, the diameter Dₑₓₚ of the stripped region, thus allows the determination, by comparison with the energy profile 34, which is the oxide removal energy density threshold Sₑₓₚ, that is the minimum energy density for removing the oxide from the surface (FIG. 2).

Furthermore, the damaged region is formed by the points on the surface 46 having received a sufficient energy density to damage the product beneath the oxide layer.

Determining the diameter D_{end} of the contour 49 of the damaged region allows to determine, by comparison with the energy profile 34, what the damage energy density threshold S_{end} is for the metal.

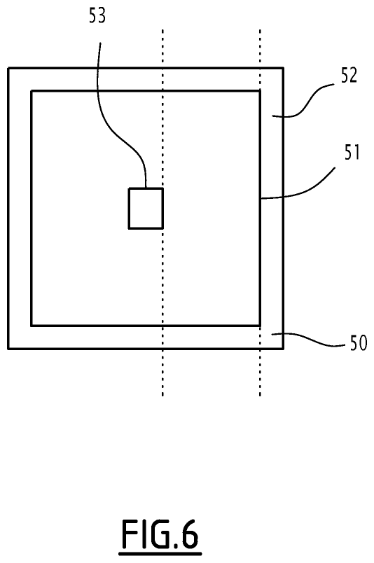

In FIG. 6, the surface 50 results from the transmission of the pulse having the energy profile 35. The contour 51, square in shape, delimits the oxide-free stripped region of the product. The surface 50 thus comprises an unstripped segment 52 and a stripped region. In this embodiment, the stripped region is square in shape. The stripped region comprises a damaged region at its center, delimited by a square contour 53.

Determining the side length of the contour 51 thus allows to determine, by comparison with the energy profile 35, the oxide removal energy density threshold Sₑₓₚ. Similarly, determining the length of the side of the damaged region allows the metal damage energy density threshold S_{end} to be determined.

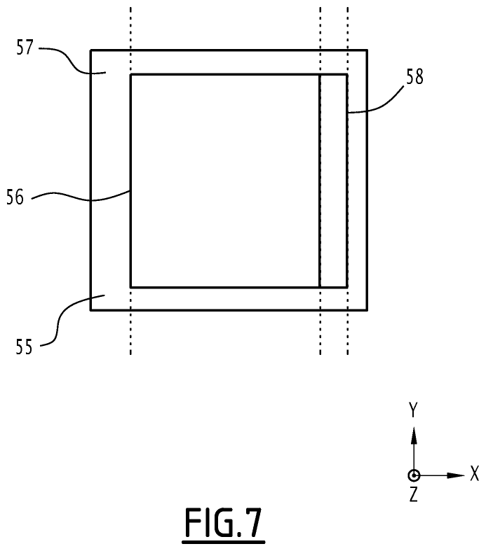

Finally, in FIG. 7, the surface 55 results from transmitting the pulse having the energy profile 36. The contour 56, rectangular in shape, delimits the oxide-free stripped region of the product. The surface 55 thus comprises an unstripped segment 57 and a stripped region. In this embodiment, the stripped region is rectangular in shape. The stripped region comprises a central damaged region, delimited by a rectangular contour 58.

Determining the length of the contour 56 according to the axis X allows the oxide removal energy density threshold Sₑₓₚ to be determined by comparison with the energy profile 36. Similarly, determining the length according to the axis X of the contour 58 of the damaged region allows the metal damage energy density threshold S_{end} to be determined.

The threshold determination module 42 is able to transmit the oxide removal energy density threshold Sₑₓₚ thus determined and, if applicable, the metal damage energy density threshold S_{end} to the apparatus 12 for laser stripping.

Preferably, the treatment system 24, in particular the threshold determination module 42, is also suitable for transmitting to the transmission system 20 the oxide removal energy density threshold and the metal damage threshold S_{end} if the latter has been determined. The transmission system 20 is then adapted to control the energy of the analysis laser pulses in such a way that transmission of the analysis laser pulses effectively results in a stripping of a portion of the impacted segment, without damaging the metal.

In particular, if transmitting a previous analysis laser pulse has not generated a stripped region (the removal energy density threshold then being non-existent), the transmission system 20 is able to receive this information from the treatment system 24. The transmission system 20 is then able to control the transmission of analysis laser pulses of higher energy than the analysis laser pulse transmitted at the previous instant.

Conversely, if the transmission of a previous analysis laser pulse has generated a damaged region, the transmission system 20 is able to receive the damage energy density threshold from the treatment system 24. The transmission system 20 is then configured to control the transmission of analysis laser pulses of lower energy than the analysis laser pulse transmitted at the previous instant, in particular energy such that the energy density of the analysis laser pulses remains below the damage energy density threshold.

To obtain a reliable measurement, it is desirable that the strip 3 maintains a constant distance relative to the energy density threshold determination assembly 10, in other words, the strip 3 must not oscillate and must remain at a fixed height. This can be achieved by applying a sufficiently large pull to the strip 3 using S-blocks, or by placing a support roller 24 under the strip 3 to ensure its fixed height under the laser pulse transmitting system 20.

For the sake of simplicity, FIG. 1 shows the energy density threshold determination assembly 10 only on the upper surface of the strip 3. But, of course, other lasers and the associated sensors are also present on the lower surface of the strip 3. Similarly, a support roller comparable to roller 24 can be placed in contact with the upper surface of the strip 3 to ensure that the strip 3 maintains a fixed distance relative to the lasers inspecting its lower surface.

The apparatus for laser stripping comprises an array of stripping lasers 13.

The stripping lasers 13 are, for example, pulsed Nd:YAG 1064 nm lasers.

These stripping lasers 13 are intended to strip the oxide layer present on the product surface.

Each stripping laser 13 is configured to transmit, onto the surface of the running product, the pulses of a beam 14 to strip it. Each pulse covers a region of the product surface known as a spot.

The apparatus for laser stripping 12 furthermore comprises a control unit 15, configured to control the stripping lasers 13, in particular to determine the operating parameters of the lasers 13 as a function of the oxide removal energy density threshold Sₑₓₚ and, where applicable, the metal damage energy density threshold S_{end}.

In particular, the control unit 15 is configured to control the stripping lasers 13 in such a way that each point of the section under consideration of the product surface is exposed in at least one instant to an energy density higher than the oxide removal energy density threshold Sₑₓₚ, as determined for this section.

To this end, the control unit 15 is configured to monitor the peak energy density transmitted by each stripping laser 13 and to control a scan of the section under consideration by the lasers, in such a way that the spots of the pulses transmitted by the stripping lasers 13 cover the entire section under consideration and in such a way that each point of this section is exposed in at least one instant to an energy density higher than the oxide removal energy density threshold Sₑₓₚ.

The peak energy density transmitted by each stripping laser 13 is chosen to be higher than the oxide removal energy density threshold Sₑₓₚ and, if necessary, less than the damage energy density threshold S_{end}.

To control such a scan, the control unit 15 comprises, for example, an optical and/or mechanical scanning system, configured to laterally displace the spots of the beams 14 on the product surface, or an optical system transforming the spots into lines.

In the same way as for the energy density threshold determination assembly 10, it is desirable that the strip 3 maintains a fixed height when passing under the stripping lasers 13, and a support roller 25 comparable to the previous support roller 24, or any other functionally equivalent device, can be used for this purpose.

Also, other lasers 13, not shown, and their possible associated support roller, are provided to strip the lower surface of strip 3, based on the oxide removal energy density threshold Sₑₓₚ, and, if applicable, the metal damage energy density threshold S_{end}.

The stripping lasers 13 can each be positioned non-perpendicular to the metal sheet in order to minimize disturbance of the incident beam by the oxide particles thrown up by previous pulses transmitted by the laser 13 itself or other lasers 13 in the row.

According to one embodiment, each section being an elementary strip, each elementary strip is treated several times by the stripping lasers in order that consecutive pulses are not absorbed by particles and/or plasma from previous pulses. In this case, a first sub-step of stripping a transverse line is carried out with pulses separated by a distance Dᵢₙₜₑᵣ equal to N times the distance between the pulses that would be necessary to obtain homogeneous coverage, then this line is passed over N times, taking care between each sub-step to shift the position of the start of the line by the distance Diₙₜer.

The number of stripping lasers 13 required to treat the entire surface of the strip 3 is minimized by the fact that each stripping laser 13 is equipped with a high-speed scanning system, either optical or mechanical, or a combination of both, which provides lateral displacement of the beam spot 14 so as to juxtapose the spots to form a continuous line covering the entire width of the strip 3, preferably with zero or minimal overlap of the spots to avoid the risk of sending excessive amounts of energy into spot overlap regions. Alternatively, the apparatus for laser stripping 12 includes a long-distance focusing device, allowing the entire width of strip 3 to be covered with a limited number of stripping lasers 13.

The use of laser stripping carried out according to the invention provides the apparatus for stripping great versatility, especially as the stripping parameters can be easily adjusted during treatment, if they are found during the operation to be less than optimal. This being the case, for example, that the spot surface of each stripping laser 13, rather than a conventional beam focusing adjustment system, can allow it to be modified.

In the vicinity of the stripping lasers 13, means (not shown) are provided for removing and preferably collecting, for example, by suction or brushing towards a container, the oxides that have been detached from the surface of the strip 3, as well as any fumes that may be generated during treatment (by the vaporization of metal particles, oxides or organic matter). In this way, a maximum quantity of these oxides can be easily recovered, to prevent them from dispersing into the ambient atmosphere and polluting it, and to make it possible to reprocess the largest portion of them with a view to recovering the metals they contain. In addition, this operation allows any oxides that may have been only imperfectly detached from the surface of strip 3 by the lasers 13 to be removed (particularly on the upper surface of the strip 3, where gravity cannot be relied upon to help detach the oxides). Finally, the suction of these dusts and vapors allows damage to the optical systems of the lasers, on which they can collect, to be avoided, causing them to heat up or even break.

Alternatively, the strip 3 circulates vertically, in such a way as to avoid oxides, detached from the surface of strip 3 by the lasers 13, from redepositing on the surface of strip 3 or on the determination assembly 10, in particular on the optics of the determination assembly 10.

After passing under the stripping lasers 13, the strip 3 is therefore, in principle, completely stripped. This is checked by suitable means, for example by means of an optical stripping quality control device such as a camera 16, or a set of such optical devices 16, which examine(s) the surface of the strip 3 over its entire width and determine(s) which regions of the strip 3 may not have been stripped in a satisfactory manner. Color differences on the surface of the strip 3 can serve as a basis for this determination. One of the advantages of the above-mentioned suction or brushing device or equivalent is also that it allows to avoid any pieces of oxide that may have remained on the upper surface (in particular) of the strip 3 while being detached from it from being wrongly considered by the camera 16 as still being present and therefore requiring further stripping to remove them.

If the results provided by the optical device 16 are not satisfactory, then further stripping can be carried out on the imperfectly stripped portions of strip 3, or to be on the safe side, the entire strip 3.

In addition, the line may comprise, following the laser stripping section, a section of wet chemical and/or electrolytic stripping tanks, which may be filled at least temporarily, to eliminate any defects found. In the event of the strip 3 being successfully stripped, these baths would remain empty.

Another solution consists of deflecting the strip 3 into the stripping bath(s) by means of vertically displaceable plunge rollers, arranged in such a way as to be able to act on the upper surface of the strip 3. In normal operation, these rollers are in a position such that they allow the running strip 3 outside of the stripping bath in the vicinity of which they are arranged. When it becomes apparent that chemical and/or electrolytic stripping of the strip 3 is locally necessary, at least one of these plunge rollers is lowered so as to press on the upper surface of the strip 3 and temporarily pass the segment of the strip 3 to be treated through the corresponding stripping bath(s) to be used.

A method for stripping a running metal product presenting on its surface an oxide layer according to one embodiment will now be described, implemented by means of the apparatus described with reference to FIG. 1.

In the example described, the stripping method is implemented after passage of the product through the annealing furnace 5.

Therefore, it should be considered, by way of example, that each section under consideration is an elementary strip with a width equal to that of the product to be stripped.

For each section of the product under consideration, the method comprises a step of determining an oxide layer removal energy density threshold, then a step of stripping as a function of the removal energy density threshold thus determined.

For each section, the step of determining an oxide layer removal energy density threshold comprises the transmission of the analysis laser pulses of wavelength and pulse duration equal to those of the stripping laser(s) 13 over a segment of the section under consideration, to form, within said segment, a stripped region devoid of the oxide layer,

The analysis laser pulses are transmitted by the transmission system 20, in particular by the laser source 30, and focused on the targeted segment by the optical device 32.

The transmission of the analysis laser pulses is controlled by the controller 26, which controls the instant at which the pulses are transmitted.

In addition, the energy of the analysis laser pulses is preferably controlled by the transmission system 20 in such a way that transmission of the analysis laser pulses effectively results in stripping a portion of the impacted segment, without damaging the metal.

The energy of the analysis laser pulses is selected, for example as a function of information received by the transmission system 20 from the treatment system 24 (in particular the threshold determination module 42), following the transmission of an analysis laser pulse at a previous instant.

In particular, if the transmission of a previous analysis laser pulse has not generated a stripped region (the removal energy density threshold then being non-existent), the transmission system 20 receives this information from the treatment system 24. The transmission system 20 then transmits analysis laser pulses of higher energy than the analysis laser pulse transmitted at the previous instant.

Conversely, if the transmission of a previous analysis laser pulse has generated a damaged region (the damage energy density threshold having then been determined by the treatment system 24), the transmission system 20 receives the damage energy density threshold from the treatment system 24. The transmission system 20 then generates the transmission of analysis laser pulses of lower energy than the analysis laser pulse transmitted at the previous instant, in particular of such energy that the energy density of the analysis laser pulses remains below the damage energy density threshold.

The product segment, in movement, then passes in front of the image acquisition system 22.

The step of determining a removal energy density threshold then comprises the capture, by the acquisition system 22, of an image of the segment of the surface impacted by the analysis laser pulses.

This image is transmitted to the treatment system 24, which then determines, from this image, the oxide removal energy density threshold Sₑₓₚ.

Preferably, the treatment system 24 also determines, from this image, the metal damage energy density threshold S_{end}.

Determining the oxide removal energy density threshold Sₑₓₚ comprises determining, from the image, a dimension of the stripped region. This dimension is determined, for example, by the image analyzer 40.

Determining the oxide removal energy density threshold Sₑₓₚ then comprises determining, from the dimension of the stripped region, the oxide layer removal energy density threshold.

The oxide layer removal energy density threshold is, for example, determined by the threshold determination module 42, from the dimension of the stripped region and information relating to the energy profile of the analysis laser pulses the transmission of which generated the stripped region.

Determining the metal damage energy density threshold S_{end} comprises determining, from the image, a dimension of a damaged region on the impacted segment. This dimension is determined, for example, by the image analyzer 40.

Determining the metal damage energy density threshold S_{end} then comprises evaluating, from the dimension thus determined, the metal damage energy density threshold.

The metal damage energy density threshold S_{end} is, for example, evaluated by the threshold determination module 42, from the dimension of the damaged region and information relating to the energy profile of the analysis laser pulses the transmission of which generated the damaged region.

Preferably, the removal energy density threshold Sₑₓₚ and the damage energy density threshold S_{end} are transmitted to the transmission system 20, in order to allow the power of the analysis laser pulses transmitted at later instants to be controlled, in such a way that the transmission of the analysis laser pulses at these later instants effectively results in stripping a portion of the impacted segment, without damaging the metal.

The product section under consideration, still in motion, then passes in front of the apparatus for laser stripping 12, where it is subjected to the stripping step.

During the stripping stage, the lasers 13 transmit laser pulses onto the section under consideration to strip it, the energy density of the pulses being higher than the determined removal energy density threshold.

In particular, the control unit 15 receives the oxide removal energy density threshold Sₑₓₚ determined for the section under consideration, and if applicable the damage energy density threshold S_{end}, and controls the lasers 13 in such a way that each point of the section under consideration is exposed in at least one instant to an energy density higher than the oxide removal energy density threshold Sₑₓₚ.

To this end, the control unit 15 monitors the peak energy density transmitted by each laser 13 and controls a scan of the section under consideration by the lasers, in such a way that the spots of the pulses transmitted by the lasers 13 cover the entire section under consideration and in such a way that each point of this section is exposed in at least one instant to an energy density threshold higher than the oxide removal energy density threshold Sₑₓₚ.

The peak energy density transmitted by each laser 13 is chosen to be higher than the oxide removal energy density threshold Sₑₓₚ and, where applicable, lower than the damage energy density threshold S_{end}.

Following stripping, the detached oxides are removed and, preferably, collected, for example, by suction or brushing in the direction of a container.

After passing under the lasers 13, the section under consideration is, in principle, completely stripped. As described above, the condition of the section is checked, for example with the aid of an optical stripping quality control device such as a camera 16, which examines the surface of the section over its entire width and determines which regions of this section may not have been stripped in a satisfactory manner.

The steps of determining an oxide layer removal energy density threshold and stripping as a function of the removal energy density threshold are carried out successively for each section of the running product.

Preferably, from one section to the next, laser source 30 is displaced relative to the production line, in particular in a direction parallel to the plane of movement of the product and orthogonal to the direction of movement (in other words, according to the product width), in such a way that the location of the segment of the product impacted by the laser source 30, orthogonal to the direction of movement of the product, varies from one section to the next.

For example, for a strip 3 of width L (according to the direction y parallel to the surface and transverse to the direction of movement), a first section will be impacted by the laser source 30 on a segment of coordinate y=y0, a second section will be impacted by the laser source 30 on a segment of coordinate y=y0+Δy and so on.

According to one embodiment, at least certain information ng to the energy profile of the pulses transmitted by the laser source 30 is not known a priori, in particular its shape or its power or energy.

If the shape of the energy profile is not known, the energy density threshold determination assembly 10 includes, for example, a system for determining this shape.

The determination system is configured to analyze the laser pulses transmitted by the transmission system 20 and to determine the shape of the energy profile. Such a determination system is particularly useful when the shape of the pulsed beam transmitted by the transmission system 20 is not stable over time.

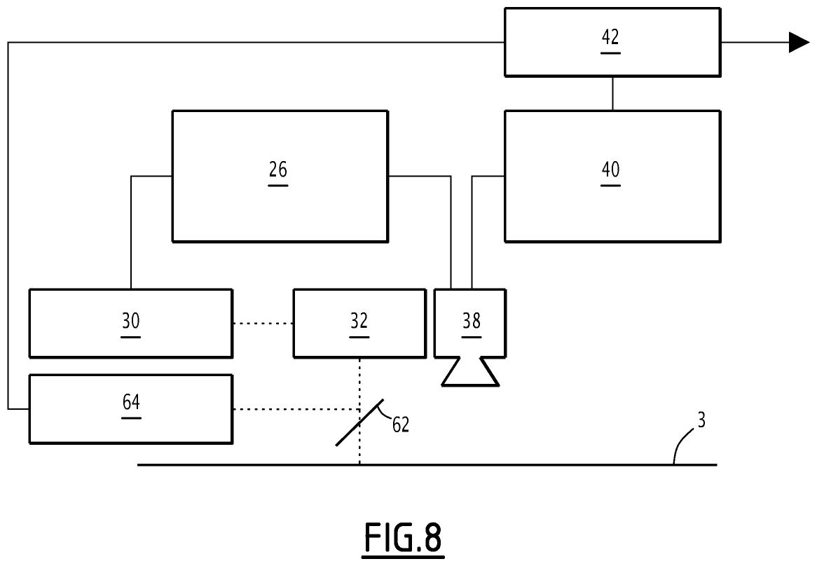

A determination system, illustrated by way of example in FIG. 8, comprises an optical device 62, for example a beam splitter, configured to deflect a portion of each analysis laser pulse transmitted by the transmission system 20 toward a beam analyzer 64.

The determination system further comprises the beam analyzer 64, configured to determine the shape of the pulse energy profile from a portion of the deflected pulse and to transmit this shape to the threshold determination module 42.

The beam analyzer 64 comprises a sensor which is held at a predetermined distance from the optical device 62, this distance being equal to the distance between the optical device 62 and the surface of the running product.

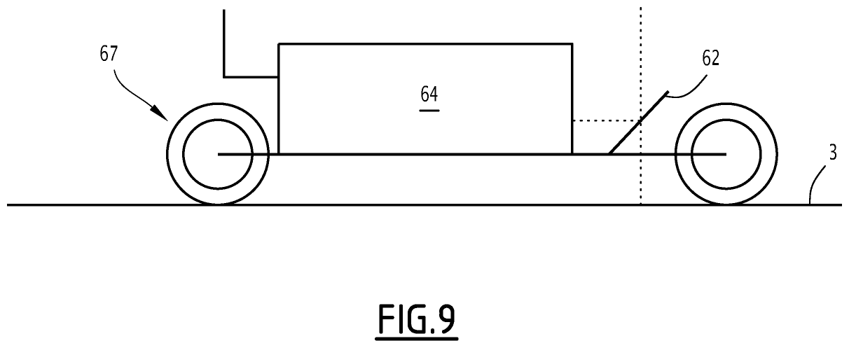

To this end, the beam analyzer 64 and the optical device 62 are, for example, mounted stationary relative to each other and to the product in the direction orthogonal to the product surface, but movable relative to the direction of movement of the strip 3. For example, as shown in FIG. 9, the beam analyzer 64 and the optical device 62 are mounted stationary on a rolling system 67 on the product 3 surface. The rolling system is movable in translation (by rolling) relative to the product in the direction x of product movement.

Thus, a constant distance is maintained between the beam analyzer 64 and the optical device 62 on the one hand, and between the optical device 62 and the product 3 surface on the other.

Furthermore, the threshold determination module 42 is configured to correct the received energy profile to take account of the fact that this profile was obtained on a portion of the pulsed beam.

According to this embodiment, the method comprises determining the shape of the profile.

Determining the shape of the profile involves, for example, deflecting a portion of the laser pulse transmitted by the transmission system 20 toward the beam analyzer 64, in particular by means of the beam splitter, and evaluating the shape of the energy profile by the beam analyzer 64.

The shape of the energy profile thus determined is then transmitted to the threshold determination module 42.

According to this embodiment, the pulse the energy profile of which is determined is an analysis laser pulse, that is, the same as that impacting the product surface in generating a stripped region.

Preferably, the energy density threshold determination assembly 10 also includes a device for determining the energy of each pulse transmitted by the laser source 30. Indeed, even when the average pulse energy is known, fluctuations in this energy are possible, and knowing the energy of each pulse transmitted by the laser source 30 onto the product surface then allows a more accurate determination of the energy density threshold(s). Such a pulse energy determination device includes, for example, a calibrated photodiode positioned on one side of the laser beam.

According to another embodiment, the shape of the energy profile of the pulses transmitted by the transmission system 20 is known, but the energy or power of the pulses is not, and the energy density threshold determination assembly 10 furthermore includes a system for determining the energy or power of the pulses transmitted by the transmission system 20.

Such a determination system is generally intended to periodically determine the power (or energy) of the pulses transmitted to carry out a recalibration, whereas the energy determination device as described above is generally intended to determine the energy of each of the pulses, in real time.

This energy determination system differs from that shown as an example in FIG. 9 essentially in that the beam analyzer 64 is replaced by a power meter.

In this embodiment, moreover, it is not necessary for the power meter to be held at a predetermined distance from the optical device which is equal to the distance between the optical device and the surface of the running product.

According to this embodiment, the method comprises determining the energy or the power of the pulse.

Determining the energy or the power of the pulse comprises, for example, deflecting a portion of the laser pulse transmitted by the transmission system 20 toward the power meter, in particular by means of the beam splitter, and evaluating the energy and/or power of the pulse by the power meter.

The pulse energy and/or power thus determined is then transmitted to the threshold determination module 42.

According to this embodiment, the pulse, the energy or power of which is determined is also the same as that impacting the product surface, generating a stripped region.

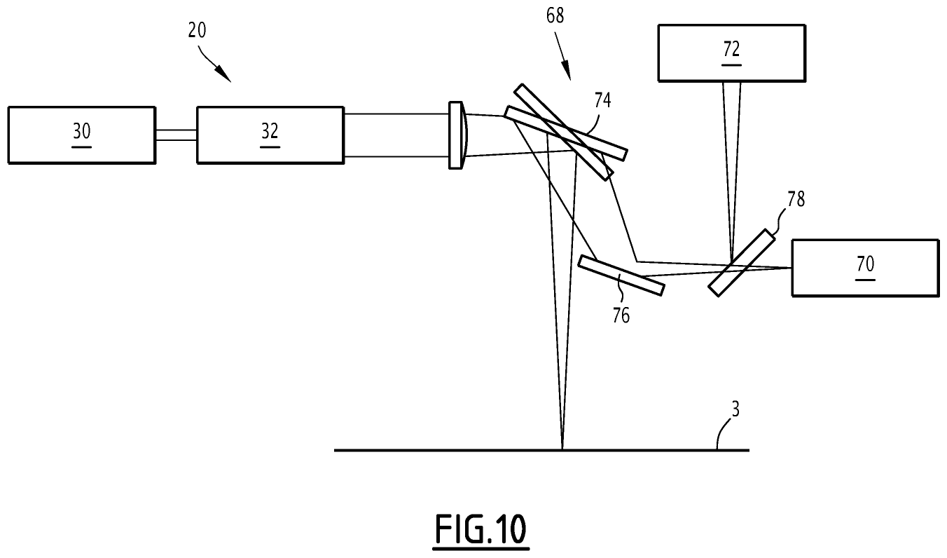

According to another embodiment, illustrated by way of example in FIG. 10, the energy profile and/or power is determined on the basis of pulses which are not pulses impacting the product surface in generating a stripped region, but pulses transmitted before or after the latter, hereinafter referred to as auxiliary pulses.

According to this embodiment, the determination system comprises an optical device 68 configured to direct the pulsed beam transmitted by the transmission system 20 selectively toward a beam analyzer and/or a power meter or toward the product surface. The determination system further comprises a beam analyzer 70 and/or a power meter 72, configured to determine the shape of the energy profile and/or the energy of the beam.

The optical device 68 comprises, for example, a galvanometer mirror scanner 74, a mirror 76 and, preferably, a beam splitter 78.

The galvanometer mirror scanning device 74 (shown in FIG. 10 in two positions) is configured to deflect the entire beam transmitted by the transmission system 20 selectively toward the product surface or toward the mirror 76.

The mirror 76 is configured to reflect the beam thus deflected toward the beam splitter 78.

The beam splitter 78 is intended to separate the pulsed beam into two sub-beams, directing one part toward the beam analyzer 70 on the other part toward the power meter 72.

If the shape of the energy profile is known, the beam analyzer 70 and the beam splitter 78 can be omitted.

Conversely, if the pulse energy is known, the power meter 72 and the beam splitter 78 can be omitted.

According to this embodiment, the method comprises the transmission of auxiliary pulses by the transmission system 20, and the orientation of these pulses toward the beam analyzer 70 and/or toward the power meter 72.

When it is desired to determine the shape of the energy profile and the energy or power, the auxiliary pulses are oriented both toward the beam analyzer 70 and/or toward the power meter 72, in particular by the beam splitter 78.

The auxiliary pulses are oriented toward the beam analyzer 70 and/or toward the power meter 72 by means of the galvanometer mirror scanning device 74.

The method then comprises the evaluation of the shape of the energy profile of the auxiliary pulses by the beam analyzer 70, and/or evaluation of the energy or the power of the pulses by the power meter 72.

The shape, the energy and/or the power determined in this way are then transmitted to the threshold determination module 42.

Once the auxiliary pulses have been transmitted, the galvanometer mirror scanner 74 orients the subsequent pulses toward the product 3 surface.

The method and apparatus according to the invention thus allow to obtain efficient stripping of metal products on an industrial scale, in particular thanks to the precise determination of the parameters able to efficiently strip the oxide layer.

In the examples shown, reference has been made to flat products such as a strip, but the invention is also applicable to other types of products, such as metal bars, tubes or metal wires.

1. A method for stripping a running metal product presenting on a surface thereof an oxide layer, said method using laser stripping by means of at least one stripping laser, the method comprising the following steps, implemented successively on each section of a plurality of consecutive sections of the running product:
determining an oxide layer removal energy density threshold on the section under consideration of said running metal product, corresponding to a minimum energy density necessary for removal of the oxide layer on the section under consideration, comprising:
transmitting analysis laser pulses by an transmission system comprising a laser source, the analysis laser pulses being of equal wavelength and pulse duration to those of the stripping laser or lasers, on a segment of said section under consideration, to form, within said segment, a stripped region devoid of the oxide layer,
capturing an image of the segment of the surface impacted by said analysis laser pulses,
determining, from said image, a dimension representative of the stripped region,
evaluating, from said representative dimension and information relative to the energy profile of the analysis laser pulses, of the oxide layer removal energy density threshold,
transmitting by the stripping laser stripping laser pulses on the section under consideration to strip the section under consideration, the energy density of the stripping pulses being higher than the determined oxide layer removal energy density threshold,
the stripping laser being controlled by a control unit receiving the determined oxide layer removal energy density threshold, in such a way that each point of the section under consideration is exposed in at least one instant to an energy density higher than the oxide layer removal energy density threshold.

2. The stripping method according to claim 1, wherein transmitting the analysis laser pulses shapes, within said segment, a damaged region, on which the metal underlying the oxide layer has been damaged, and the method further comprises determining, from said image, a dimension representative of the damaged region and evaluating, from the dimension representative of the damaged region and the information relating to the energy profile of the analysis laser pulses, a metal damage energy density threshold, corresponding to the energy density above which degradation of the surface of the metal product, beneath the oxide layer, is observed.

3. The stripping method according to claim 2, further comprising transmitting the damage energy density threshold to the transmission system, and wherein, on the next section of the running metal product, the transmission system transmits an analysis laser pulse of energy adapted in such a way that at any point of the segment impacted by the analysis laser pulses, the energy density is lower than the damage energy density threshold.

4. The stripping method according to claim 1, wherein the information relating to the energy profile comprises the shape of the energy profile and the energy or power of the analysis laser pulses.

5. The stripping method according to claim 4, wherein the step of determining the oxide layer removal energy density threshold comprises determining the shape of the energy profile of the analysis laser pulses and/or determining the energy or power of the analysis laser pulses.

6. The stripping method according to claim 5, wherein the step of determining the oxide layer removal energy density threshold comprises determining the energy profile shape of the analysis laser pulses, comprising diverting a portion of each analysis laser pulse to a beam analyzer and evaluating the energy profile shape by the beam analyzer.

7. The stripping method according to claim 5, wherein the step of determining the oxide layer removal energy density threshold comprises determining the energy and/or power of the analysis laser pulses, comprising diverting a portion of each analysis laser pulse toward a power meter, and evaluating the energy and/or power of the analysis laser pulses by the power meter.

8. The stripping method according to claim 4, wherein the step of determining the oxide layer removal energy density threshold comprises determining the shape of the energy profile and/or the energy or power of auxiliary laser pulses transmitted by the transmission system, the auxiliary laser pulses being distinct from the analysis laser pulses.

9. The stripping method according to claim 8, wherein the determination of the shape of the energy profile and/or the energy or power of the auxiliary laser pulses comprises:
transmission of the auxiliary laser pulses by the transmission system,
orientation of the auxiliary laser pulses toward a beam analyzer and/or toward a power meter by means of a galvanometer mirror scanning device,
evaluation of the shape of the energy profile of the auxiliary laser pulses by the beam analyzer and/or evaluation of the energy and/or power of the auxiliary laser pulses by the power meter.

10. The stripping method according to claim 1, wherein the metal product is a strip, a bar, a sheet, a plate, a tube or a wire.

11. An apparatus for laser stripping of a running metal product presenting on its surface an oxide layer by means of at least one stripping laser, the apparatus comprising:
a determination assembly configured to determine, on each of a plurality of successive sections of the running metal product, an oxide layer removal energy density threshold, corresponding to a minimum energy density necessary for removal of the oxide layer on the section under consideration, the determination assembly comprising:
a transmission system comprising a laser source, the transmission system being configured to transmit, on a segment of said section under consideration, the analysis laser pulses of wavelength and pulse duration equal to those of the stripping laser(s), to form, within said segment, a stripped region devoid of the oxide layer,
an image acquisition system configured to acquire an image of the segment impacted by the analysis laser pulses, during running of the product,
a treatment system configured to determine, from each image acquired by the image acquisition system, a dimension representative of the stripped region and to evaluate, from said representative dimension and information relating to the energy profile of the analysis laser pulses, the oxide layer removal energy density threshold,
an apparatus for laser stripping comprising at least one stripping laser configured to transmit the stripping laser pulses on each of the plurality of successive sections of the running metal product to strip the running metal product, and a control unit configured to receive the oxide layer removal energy density threshold for that section and to control transmission, by the stripping laser(s), of laser pulses of energy higher than the oxide layer removal energy density threshold, in such a way that each point of the section under consideration is exposed for at least one instant to an energy density higher than the oxide removal energy density threshold.

12. A laser stripping apparatus according to claim 11, wherein the analysis laser pulses are adapted to form, within said segment, a damaged region, on which the metal underlying the oxide layer has been damaged by the analysis laser pulses, and the treatment system is configured to determine, from said image, a dimension representative of the damaged region and to evaluate, from the dimension representative of the damaged region and the information relating to the energy profile of the analysis laser pulses, a metal damage energy density threshold, corresponding to the energy density above which degradation of the surface of the metal product, beneath the oxide layer, is observed.

13. The laser stripping apparatus according to claim 12, wherein the treatment system is configured to transmit the damage energy density threshold to the transmission system, and wherein the transmission system is configured to adapt the energy of the analysis laser pulse as a function of the damage energy density threshold in such a way that at any point of the impacted segment of the following section of the product in movement, the energy density is lower than the damage energy density threshold.

14. The laser stripping apparatus according to claim 11, wherein, the information relating to the energy profile comprising the shape of the energy profile and the energy or power of the analysis laser pulses, the apparatus for laser stripping comprises a system for determining the shape of the energy profile of the analysis laser pulses and/or a system for determining the energy or power of the analysis laser pulses.

15. The laser stripping apparatus according to claim 14, wherein the system for determining the shape of the energy profile of the analysis laser pulses comprises a beam analyzer and an optical device, configured to deflect a portion of each analysis laser pulse toward the beam analyzer, the beam analyzer being configured to evaluate the shape of the energy profile from the deflected portion of the analysis laser pulse.

16. The laser stripping apparatus according to claim 14, wherein the system for determining the energy or power of the analysis laser pulses comprises a power meter and an optical device, configured to deflect a portion of each analysis laser pulse toward the power meter, the power meter being configured to evaluate the energy and/or power of the analysis laser pulses from the deflected portion of the analysis laser pulse.

17. The stripping apparatus according to claim 11, wherein, the information relating to the energy profile comprising the shape of the energy profile and the energy or power of the analysis laser pulses, the apparatus for laser stripping comprises a system for determining the shape of the energy profile and/or the energy or power of auxiliary laser pulses transmitted by the transmission system, the auxiliary laser pulses being distinct from the analysis laser pulses.

18. The stripping apparatus according to claim 11, wherein, in order to treat the entire surface of said metal product which consists of a strip, a bar, a tube, a sheet, a plate or a wire, the apparatus comprises, distributed in the vicinity of said metal product, a group of laser sources and a group of stripping lasers.
